(19) United States
(12) Patent Application Publication
(10) Pub. No.: US 2013/0007020 A1
(43) Pub. Date: Jan. 3, 2013

(54) METHOD AND SYSTEM OF EXTRACTING CONCEPTS AND RELATIONSHIPS FROM TEXTS

(76) Inventors: Sujoy Basu, Sunnyvale, CA (US); Sharad Singhal, Belmont, CA (US)

(21) Appl. No.: 13/173,643

(22) Filed: Jun. 30, 2011

(51) Int. Cl. G06F 7/00

(52) U.S. Cl. 707/750; 707/E17.058

(57) ABSTRACT

An exemplary embodiment of the present techniques extracts concepts and relationships from a text. Concepts may be generated from the text using singular value decomposition, and ranked based on a term weight and a distance metric. The concepts that are ranked above a particular threshold may be iteratively extracted, and the concepts may be merged to form larger concepts until the generation of concepts has stabilized. Relationships may be generated based on the concepts using singular value decomposition, then ranked based on various metrics. The relationships that are ranked above a particular threshold may be extracted.

### BACKGROUND

Enterprises typically generate a substantial number of documents and software artifacts. Access to relatively cheap electronic storage has allowed large volumes of documents and software artifacts to be retained, which may cause an “information explosion” within enterprises. In view of this information explosion, managing the documents and software artifacts has become vital to the efficient usage of the extensive knowledge contained within the documents and software artifacts. Information management may include assigning a category to a document, as used in retention policies, or tagging documents in service repositories. Moreover, information management may include generating search terms, as in e-discovery.

### BRIEF DESCRIPTION OF THE DRAWINGS

Certain exemplary embodiments are described in the following detailed description and in reference to the drawings, in which:

FIG. 1 is a process flow diagram showing a method of preprocessing texts and extracting concepts and relationships from texts according to an embodiment of the present techniques;

FIG. 2A is a process flow diagram showing a method of concept generation according to an embodiment of the present techniques;

FIG. 2B is a process flow diagram showing a method of relationship generation according to an embodiment of the present techniques;

FIG. 3 is a subset of a mind map which may be rendered to visualize results according to an embodiment of the present techniques;

FIG. 4 is a block diagram of a system that may extract concepts and relationships from texts according to an embodiment of the present techniques; and

FIG. 5 is a block diagram showing a non-transitory, computer-readable medium that stores code for extracting concepts and relationships from texts according to an embodiment of the present techniques.

### DETAILED DESCRIPTION OF SPECIFIC EMBODIMENTS

The documents and software artifacts of an enterprise may be grouped in order to represent a domain, which can be generally described as a corpus of documents and various other texts containing various concepts and relationships within an enterprise. As used herein, a document may include texts, and both documents and texts may contain language that describes various concepts and relationships. Extracting the concepts and relationships within a domain may be difficult unless some prior domain knowledge is loaded into the extraction software before runtime. Unfortunately, the amount of effort used in building and maintaining such domain knowledge can limit the scenarios in which the software can be applied. For example, if the concepts to be extracted have no relationship to the preloaded domain knowledge, the software may not be successful in extracting the particular concepts.

Accordingly, embodiments of the present techniques may provide automatic extraction of concepts and relationships within a corpus of documents representative of a domain without any background domain knowledge. These techniques may be applied to any corpus of documents and texts, and domain knowledge prior to runtime is optional. Further, named relationships expressed by verbs may be extracted. These named relationships may be distinct from taxonomic relationships, which can express classification of concepts by subtyping or meronymic relationships. A subtype typically describes an “is a” relationship while a meronym typically describes a part of a whole. For example, subtyping may include recognizing a ‘laptop’ is a ‘computer’ and meronymic relationships may include recognizing that a central processing unit (CPU) is a part of a computer.

Further, an embodiment of the present techniques includes an iterative process that may cycle over the concepts present in the document corpus. Each iteration over the concepts builds on the previous iteration, forming more complex concepts, and eliminating incomplete concepts as needed. This may be followed by a single iteration of the relationship extraction phase, where verbs describing named relationships are extracted along with the connected pair of concepts.

Moreover, an embodiment of the present techniques may use singular value decomposition (SVD). SVD is a matrix decomposition technique and may be used in connection with a latent semantic indexing (LSI) technique for information retrieval. The application of SVD in LSI is often based on the goal of retrieving documents that match query terms. Extracting concepts among the documents may depend on multiple iterations of SVD. Each iteration over concepts may be used to extract concepts of increasing complexity. In a final iteration, SVD may be used to identify the important relationships among the extracted concepts. In comparison to an information retrieval case where SVD determines the correlation of terms to one another and to documents, iteratively extracting concepts leads to the use of SVD to determine the importance of concepts and relationships.

Overview

Knowledge acquisition from text based on natural language processing and machine learning techniques includes many different approaches for extracting knowledge from texts. Approaches based on natural language parsing may look for patterns containing noun phrases (NP), verbs (V), and optional prepositions (P). For example, common patterns can be NP-V-NP or NP-V-P-NP. When extracting relationships, the verb, with an optional preposition, may become the relationship label. Typically, approaches using patterns containing noun phrases have the benefit of domain knowledge prior to runtime.

Various approaches to extract relationships may be compared in measures of precision and recall. Precision may measure accuracy of a particular technique as the fraction of the output of the technique that is part of the ground truth. Recall may measure the coverage of the relationships being discovered as a fraction of the ground truth. The ground truth may be obtained by a person with domain knowledge reading the texts provided as input to the technique, and is a standard by which proposed techniques are evaluated. This person may not look at the output of the technique to ensure there is no human bias. Instead, the person may read the texts and identify the relationships manually. The relationships identified by the person may be taken as the ground truth. Multiple people can repeat this manual task, and there are approaches to factor their differences in order to create a single ground truth.

For example, in relationship discovery, consider the following ground truth where a set of five relationships, {r1, r2, r3, r4, r5}, have been identified by a human from a corpus. If the output of a particular technique for relationship extraction is {r1, r2, r6, r7}, the precision is {r1, r2} out of {r1, r2, r6, r7}, or 2/4=50%. Only 50% of the output of this particular technique is accurate. Moreover, the recall of the particular technique is {r1, r2} out of {r1, r2, r3, r4, r5} or 2/5=40%. Only 40% of the ground truth was covered by the particular technique. High precision may be achieved when recall is low, due to high precision typically employing a more selective technique. As a result, both recall and precision may be compared. Moreover, various filtering strategies may be compared so that the relationships being discovered have a higher precision and recall.

Technique

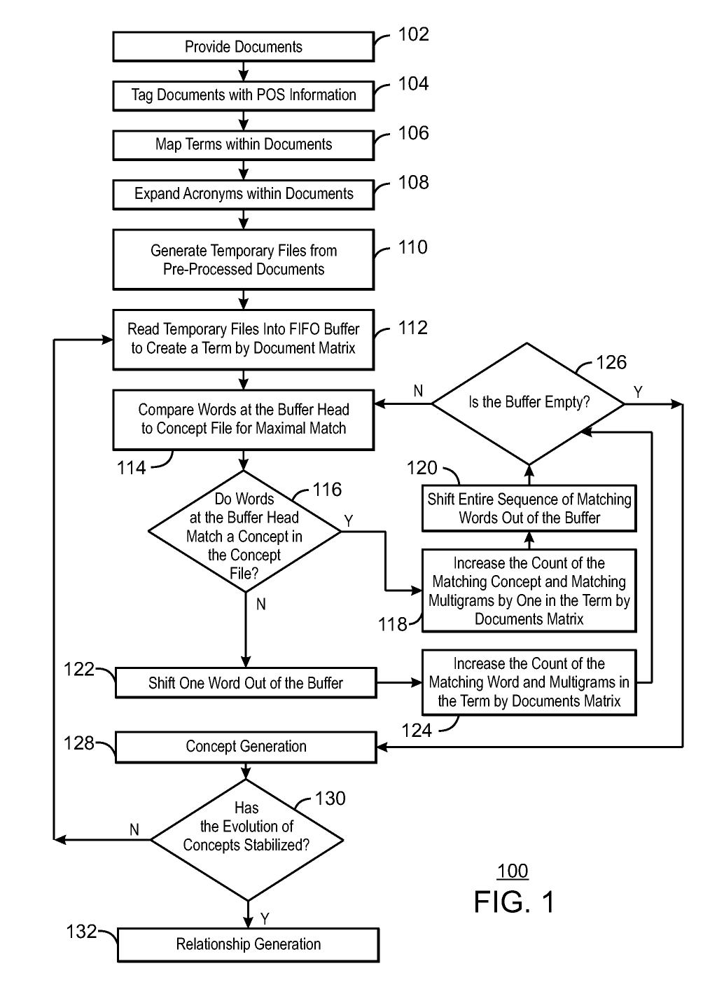

FIG. 1 is a process flow diagram showing a method 100 of preprocessing texts and extracting concepts and relationships from texts according to an embodiment of the present techniques. At block 102, a corpus of natural-language documents representing a coherent domain is provided. The corpus of natural language documents may elaborate on the domain in a way that a reader can understand the important concepts and their relationships. In some scenarios, the “documents” may be a single large document that has been divided into multiple files at each section or chapter boundary.

At block 104, the text within the documents may be tagged with parts-of-speech (POS) tags. For example, a tag may be NN for noun, JJ for adjective, or VB for verb, according to the University of Pennsylvania (Penn) Treebank tag set. The Penn Treebank tag set may be used to parse text to show syntactic or semantic information.

At block 106, plural forms of words may be mapped to their singular form, and at block 108, terms may be expanded by including acronyms. At block 110, the tagged documents may be read and filtered by various criteria to generate a temporary file. The first criterion may be parts of speech. In this manner, nouns, adjectives, and verbs are retained within the file. Stop words, such as ‘is’, may be removed. The second criterion may include stemming plural words. Stemming plural words may allow for representing plural words by their singular form and their root word. The third criterion may include replacing acronyms by their expansion in camel-case notation, based on a file containing such mappings that can be provided by the user. Other words in the files may be converted to lower case. Finally, the fourth criterion may not use differences among the various parts-of-speech tags. For example, all forms of nouns labeled as “INN”, regardless of the specific type of noun.

At block 112, the temporary files are read one by one into a first in, first out (FIFO) buffer to generate a term by document matrix at the beginning of the first iteration of the concept generation phase. Each column in this matrix may represent a file, while each row may represent a term. Further, each term can be a unigram or a multi-gram consisting of at most N unigrams, where N is a threshold. A unigram may be a single word or concept in camel-case notation as is discussed further herein. A multi-gram, also known as n-gram, may be a sequence of n unigrams, where n is an integer greater than 1.

At block 114, the words at the buffer head may be compared to a concept in a concept file. The concept file may be empty at the first iteration or it may contain seed concepts provided by the user. At block 116, it is determined if the words at the buffer head match a concept in the concept file. If the words at the head of the buffer match a concept in the concept file, the method continues to block 118.

At block 118, a count of the matching concept in the term by document matrix may be incremented by 1. Additionally, the count of all multi-grams starting with that concept are incremented by 1. At block 120, the entire sequence of matching words that form a concept may be shifted out of the FIFO buffer. If the words at the head of the buffer do not match a concept in the concept file at block 116, the method continues to block 122. At block 122, one word is shifted out of the FIFO buffer. At block 124, the count for this word is incremented as well as the count of all multi-grams that begin with it. As words are shifted out the FIFO buffer, the empty slots at the tail of the FIFO buffer may be filled with words from the temporary file. Typically, the FIFO buffer is smaller in size than the temporary file. The empty slots in the FIFO buffer that occur after words have been shifted out of the FIFO buffer may be filled with words from the temporary file in a sequential fashion from the point where words were last pulled from the temporary file. The process of filling the FIFO buffer may be repeated until the entire temporary file goes through the FIFO buffer.

After block 120 or block 124, at block 126 it is determined if the FIFO buffer is empty. If the FIFO buffer is not empty, the method returns to block 114. If the FIFO buffer is empty, the method continues to block 128. After each file has been through the FIFO buffer, the term by document matrix may be complete. All terms, or rows, in the term by document matrix for which the maximum count does not exceed a low threshold may be removed.

At block 128, concept generation may be iteratively performed. First, a singular-value decomposition (SVD) of the term by document matrix may be performed. After applying SVD, the sorted list of terms, based on a term weight and a distance metric, is generated. The terms may be unigrams, bigrams, trigrams, and, in general, n-grams, where n is a threshold during multi-gram generation. All n-grams that follow acceptable patterns for candidate multi-grams may be selected. The first acceptable pattern is a multi-gram with only concepts or nouns. The second acceptable pattern is a multi-gram with qualified nouns or concepts. The qualifier may be an adjective, which allows the formation of a complex concept. More complex patterns can be explicitly added. Additionally, as further described herein, the new concepts discovered may be added to the concept file to begin the next iteration.

At block 130, it is determined if the concept evolution has stabilized. Concept evolution generally stabilizes when subsequent iterations fail to find any additional complex concepts. If the concept evolution has not stabilized, the method returns to block 112. If the concept evolution has stabilized, the method continues to block 132. At block 132, the relationship generation phase is performed. In the relationship generation phase, potentially overlapping triples may be counted as terms. Triples may consist of two nouns or concepts separated by a verb, or verb and preposition, or noun and preposition, or any other pattern known for relationships. The counting of triples may be done in a manner similar to counting of multi-grams in the concept generation phase, as further described herein. This process may create another term by document matrix, where the terms may be triples found in the iterative concept generation phase. As each concept or noun is shifted out of the buffer, its count may be incremented by 1. Also, the count of all triples that include it as the first concept or noun may also be incremented by 1. After the other term-by-document matrix is constructed, and the SVD computation is done, the sorted list of triples based on term weight and distance metric may be generated.

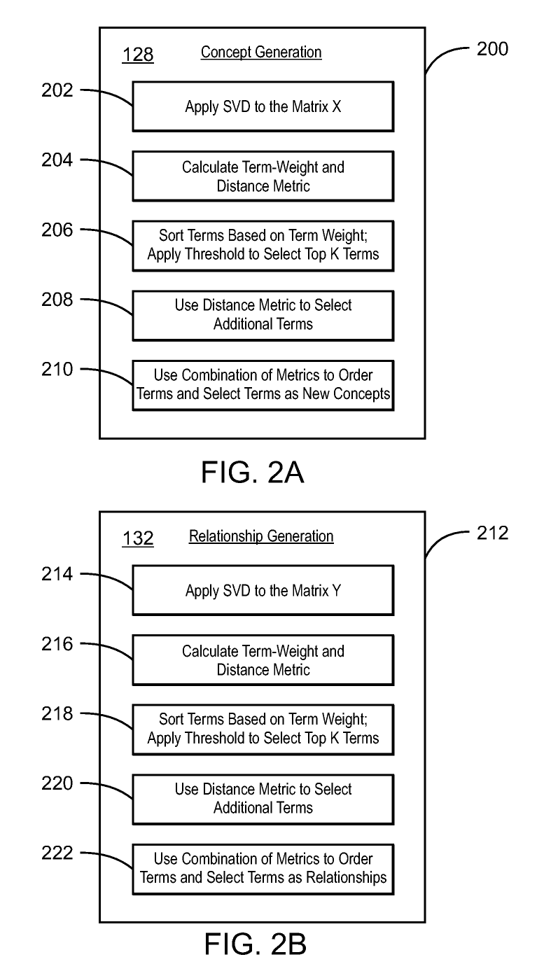

FIG. 2A is a process flow diagram showing a method 200 of concept generation according to an embodiment of the present techniques. Concept generation may occur at block 128 of FIG. 1.

At block 202, SVD may be applied to a term by document matrix X. The term by document matrix X may have rows representing terms and columns representing documents. The creation of a term by document matrix is generally described herein at blocks 102-126 (FIG. 1). An element of the matrix X may represent the frequency of a term in a document of the corpus being analyzed.

The SVD of matrix X may express the matrix X as the product of 3 matrices, T, S and D^{t}, where S is a diagonal matrix of singular values, which are non-negative scalars, ordered in descending order. Matrix T may be a term matrix, and matrix D^{t} may be a transpose of the document matrix. The smallest singular values in S can be regarded as “noise” compared to the dominant values in S. By retaining the top k singular values and corresponding vectors of T and D, the best rank k approximation of X is obtained that may minimize a mean square error from X over all matrices of its dimensionality that have rank k. As a result, the SVD of matrix X is typically followed by “cleaning up” the noisy signal.

Matrix X may also represent the distribution of terms in natural-language text. The dimension of X may be t by d, where t represents the number of terms, and d represents the number of documents. The dimension T is t by m, where m represents the rank of X and may be at most the minimum of t and d. The dimension of S may be m by m. The “cleaned up” matrix may be a better representation of the association of important terms to the documents.

After clean up is performed, the top k singular values in S, and the corresponding columns of T and D, may be retained. The new product of Tₖ, Sₖ and Dₖ^{t} is a matrix Y with the same dimensionality as X. Matrix Y is generally the rank k approximation of X. Rank k may be selected based on a user defined threshold. For example, if the threshold is ninety-nine percent, k may be selected such that the sum of squares of top k singular values in S is ninety-nine percent of the sum of all singular values.

At block 204, a term weight and a distance metric may be calculated based on the results of SVD. Intuitively, SVD may transform the document vectors and the term vectors into a common space referred to as the factor space. The document vectors may be the columns of X, while the term vectors may be the rows of X. The singular values in S may be weights that can be applied to scale the orthogonal, unit-length column vectors of matrices T and D^{t} and determine where the corresponding term or document is placed in the factor space.

Latent semantic indexing (LSI) is the process of using the matrix of lower rank to answer similarity queries. Similarity queries may include queries that determine which terms are strongly related. Further, similarity queries may find related documents based on query terms. Similarity between documents or the likelihood of finding a term in a document can be estimated by computing distances between the coordinates of the corresponding terms and documents in this factor space, as represented by their inner product. The pairs of distances can be represented by matrices: XX^{t} for term-term pairs, X^{t}X for document-document pairs, and X for term-document pairs. Matrix X may be replaced by matrix Y to compute these distances in the factor space. For example, the distances for term-term pairs are:

YY^{t}=TₖSₖDₖ^{t}(TₖSₖDₖ^{t})^{t}=TₖSₖDₖ^{t}DₖSₖTₖ^{t}=TₖSₖSₖTₖ^{t}=TₖSₖ(TₖSₖ)^{t}

Thus, by taking two rows of the product TₖSₖ and computing the inner product, a distance metric may be obtained in factor space for the corresponding term-term pair.

While the distance metric is important in information retrieval, it may not directly lead to the importance of a term in the corpus of documents. Important terms tend to be correlated with other important terms, since key concepts may not be described in isolation within a document. Moreover, important terms may be repeated often. Intuitively, the scaled axes in the factor space capture the principal components of the space and the most important characteristics of the data. For any term, the corresponding row vector in TₖSₖ represents its projections along these axes. Important terms that tend to be repeated in the corpus and are correlated to other important terms typically have a large projection along one of the principal components.

After the application of SVD, the columns of Tₖ may have been ordered based on decreasing order of values in Sₖ. As a result, a large projection can be seen as a high absolute value, usually in one of first few columns of TₖSₖ. Accordingly, term weight may be computed from its row vector in TₖSₖ, [t₁s₁, t₂s₂, . . . , tₖsₖ] as t_{wt}=Max(Abs(tᵢsᵢ)), i=1, 2, . . . , k. It may be necessary to take the absolute value, since in some scenarios important terms with large negative projections may be present. Furthermore, by taking the inner product of two term vectors, the resulting distance metric may be used to describe how strongly the two terms are correlated across the documents. Together, the term weight and distance metric may be used in an iterative technique for extracting important concepts of increasing length.

At block 206, the terms may be sorted based on the term weights. Additionally, a threshold may be applied to select only a fraction at the top of the sorted list as concepts. During the sorting operation, the distance metric may be applied to the term vector of the first and last word or concept in the bi-gram or tri-gram as the secondary sorting key. At block 208, the distance metric may be used to select additional terms. Further, the sorted terms may be merged based on the distance metric. For example, a bi-gram consisting of “HealthCare/CONCEPT” and “Provider/NN” may be added to the list of seed concepts as a new concept “HealthCareProvider”, if it is within the fraction defined by the threshold. The merged list of concepts may serve as seed concepts for the next iteration. At block 210, a combination of metrics may be used to order terms and select terms as new concepts. The combination of metrics may include a primary sorting key using the term weight, and a secondary sorting key using the distance metric applied to the first and last word or concept in the term. Alternately, a single sorting key may be used that is a function of the term weight and distance metric. The function may be a sum or product of these metrics, and the product may be divided by the number of nouns or concepts in the term. From this sorted and ordered list of concepts, important bi-grams and tri-grams that have all nouns or nouns with at most one adjective may be added to the user-provided seed concepts or concept file to complete an iteration.

During a concept generation iteration, each occurrence of a concept in the corpus of documents may be merged into a single term for the concept in camel-case notation. Further, merging the concepts may include sorting and ordering the list of concepts into a single term for the concept in camel-case notation. Camel-case notation may capitalize the first letter of each term in a concept as in “HealthCareProvider”. The term-by-document matrix may be reconstructed based on the updated corpus before a new concept generation iteration begins. After the SVD computation and extraction of important terms occurs in a new iteration, multi-grams, or n-grams, may be found with values of n that increase in subsequent iterations, since each of the three components of a trigram can be a concept from a previous iteration. As a result, in successive iterations, the number of complex concepts in the term by document matrix may increase, while the number of single words may decrease.

FIG. 2B is a process flow diagram showing a method 212 of relationship generation according to an embodiment of the present techniques. Relationship generation may occur at block 132 of FIG. 1. Another term by document matrix Z may be constructed. However, the terms now include single words, concepts and triples. Multi-grams may not be included since new concepts may not be formed.

At block 214, SVD is performed on the other term by document matrix Z. The distance of the verb from the surrounding concepts in the triples included may be parameterized, and triples may overlap, such that the first concept and verb are shared. However, the second concept may be different and both alternatives may occur within the same sentence and are within the distance allowed from the verb. When the terms in the output of SVD are sorted, triples may be found containing important named relationships between concepts.

At block 216, various metrics may be computed, including another term weight and another distance metric. For example, the importance of the relationship may be determined by the term weight of a triple and the distance metric applied to the term vectors of the two concepts in it. Various other metrics, such as the number of elementary words in the concepts connected by the relationship and a term frequency multiplied by inverse document frequency (TFIDF) weight of the concepts, may be used to study how the importance of the relationships can be altered.

Term frequency may be defined as the number of occurrences of the term in a specific document. However, in set of documents of size N on a specific topic, some terms may occur in all of the documents and do not discriminate among them. Inverse document frequency may be defined as a factor that reduces the importance of terms that appear in all documents, and may be computed as:

log(N/(Document Frequency))

Document frequency of a term may be defined as the number of documents out of N in which the term occurs.

At block 218, terms may be sorted based on the other term weight, and a threshold may be applied to select a fraction at the top of the sorted list as relationships. The number of identified relationships may result in a higher recall purely at the lexical level when compared to previous methods. Techniques for addressing synonymy can be applied to the verbs describing the relationships to improve the recall significantly. At block 220, the other distance metric may be used to select additional terms. At block 222, a combination of metrics may be used to order terms and select terms and relationships.

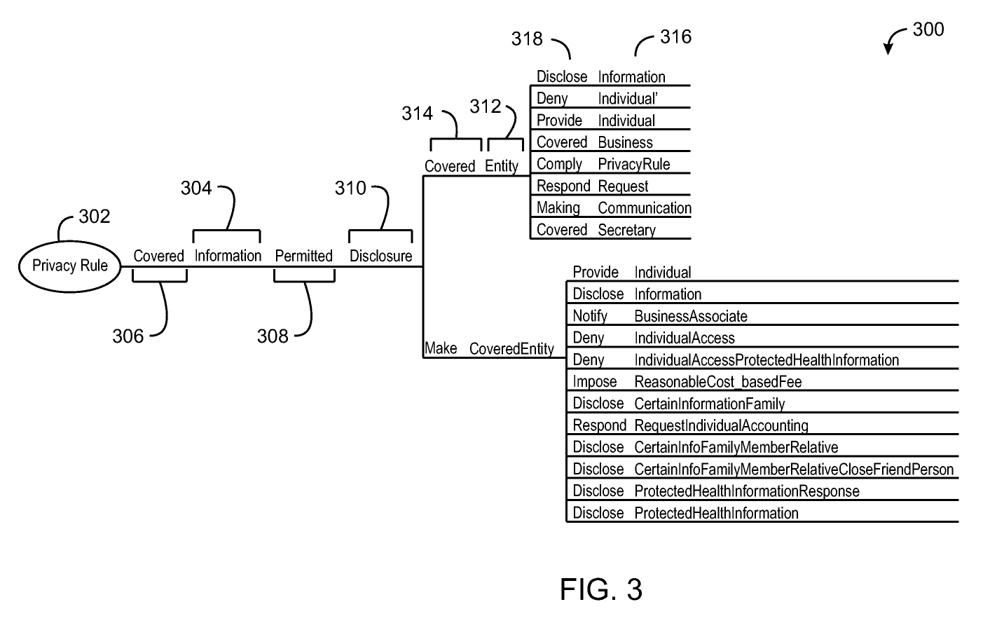

FIG. 3 is a subset 300 of a mind map which may be rendered to visualize the results according to an embodiment of the present techniques. As used herein, a mind map shows extracted concepts and relationships between the concepts. To allow a human user to inspect the extracted concepts and relationships and retain the important concepts and relationships, only a subset of the mind map is presented at a time. For ease of description, a seed concept at reference number 302 of “PrivacyRule” is used in the subset 300, but any concepts or relationships can be rendered using the present techniques.

The subset 300 may be rendered when the user is focused on the seed concept at reference number 302 of “PrivacyRule”, which may be found in a corpus of documents related to the Health Insurance Portability and Accountability Act (HIPAA). Concepts related to this seed concept at reference number 302 may be discovered, retrieved, and the concepts and corresponding relationships may be extracted rendered in a tree diagram format.

For example, the seed concept at reference number 302 of “PrivacyRule” may be provided by the user or generated according to the present techniques. During concept generation, the concept “PrivacyRule” may be found to be related to the concept “information” at reference number 304 through the relation “covered” at reference number 306. Further, a second relation “permitted” at reference number 308 connects the concept “information” at reference number 304 with the concept “disclosure” at reference number 310. Thus, the rendered relationship shows that certain information is covered by the Privacy Rule, and for such information, certain disclosures are permitted. Similarly, “disclosure” at reference number 310 is linked to the concept “entity” at reference number 312 through the relation “covered” at reference number 314, which may establish that disclosures may be related to covered entities. Continuing in this manner, “entity” at reference number 312 is related to “information” at reference number 316 by “disclose” at reference number 318, which may establish that covered entities may disclose certain information. Rendering the extracted relationships in this format may allow the user to quickly understand a summary of how the different concepts may be related in the within the corpus of documents.

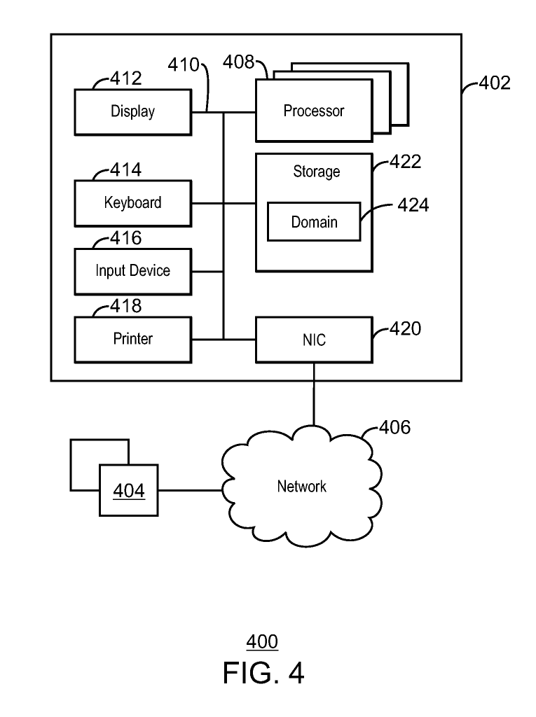

FIG. 4 is a block diagram of a system that may extract concepts and relationships from texts according to an embodiment of the present techniques. The system is generally referred to by the reference number 400. Those of ordinary skill in the art will appreciate that the functional blocks and devices shown in FIG. 4 may comprise hardware elements including circuitry, software elements including computer code stored on a tangible, machine-readable medium, or a combination of both hardware and software elements. Additionally, the functional blocks and devices of the system 400 are but one example of functional blocks and devices that may be implemented in an embodiment. Those of ordinary skill in the art would readily be able to define specific functional blocks based on design considerations for a particular electronic device.

The system 400 may include a server 402, and one or more client computers 404, in communication over a network 406. As illustrated in FIG. 4, the server 402 may include one or more processors 408 which may be connected through a bus 410 to a display 412, a keyboard 414, one or more input devices 416, and an output device, such as a printer 418. The input devices 416 may include devices such as a mouse or touch screen. The processors 408 may include a single core, multiples cores, or a cluster of cores in a cloud computing architecture. The server 402 may also be connected through the bus 410 to a network interface card (NIC) 420. The NIC 420 may connect the server 402 to the network 406.

The network 406 may be a local area network (LAN), a wide area network (WAN), or another network configuration. The network 406 may include routers, switches, modems, or any other kind of interface device used for interconnection. The network 406 may connect to several client computers 404. Through the network 406, several client computers 404 may connect to the server 402. Further, the server 402 may access texts across network 406. The client computers 404 may be similarly structured as the server 402.

The server 402 may have other units operatively coupled to the processor 408 through the bus 410. These units may include tangible, machine-readable storage media, such as storage 422. The storage 422 may include any combinations of hard drives, read-only memory (ROM), random access memory (RAM), RAM drives, flash drives, optical drives, cache memory, and the like. The storage 422 may include a domain 424, which can include any documents, texts, or software artifacts from which concepts and relationships are extracted in accordance with an embodiment of the present techniques. Although the domain 424 is shown to reside on server 402, a person of ordinary skill in the art would appreciate that the domain 424 may reside on the server 402 or any of the client computers 404.

The storage 422 may include code that when executed by the processor 408 may be adapted to generate concepts from the text using singular value decomposition and rank the concepts based on a term weight and a distance metric. The code may also cause processor 408 to iteratively extract the concepts that are ranked above a particular threshold and merge the concepts to form larger concepts until concept generation has stabilized. The storage 422 may include code that when executed by the processor 408 may be adapted to generate relationships based on the concepts using singular value decomposition, rank the relationships based on various metrics, and extract the relationships that are ranked above a particular threshold. The client computers 404 may include storage similar to storage 422.

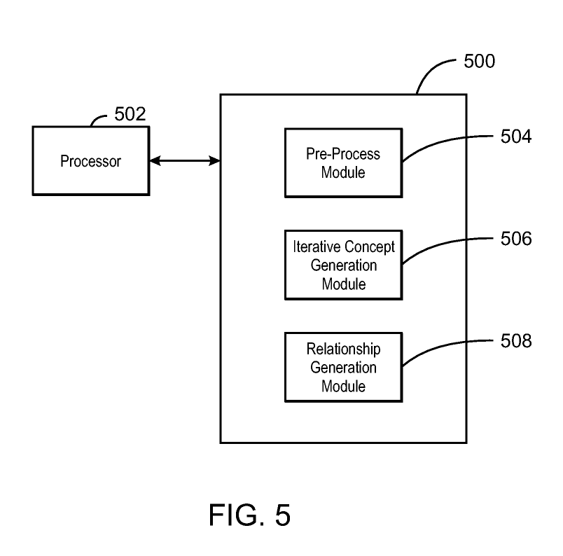

FIG. 5 is a block diagram showing a non-transitory, computer-readable medium that stores code for extracting concepts and relationships from texts. The non-transitory, computer-readable medium is generally referred to by the reference number 500.

The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 502 generally retrieves and executes the computer-implemented instructions stored in the non-transitory, computer-readable medium 500 for extracting concepts and relationships from texts. At block 504, documents are preprocessed using a pre-process module. Preprocessing the documents may include tagging the texts within each document as well as creating temporary files based on the documents. The temporary files may be loaded into a FIFO buffer. At block 506, concepts may be generated, ranked, and extracted from the pre-processed documents using an iterative concept generation module. Concept generation may iterate and merge concepts until the evolution of concepts has stabilized. At block 508, relationships are generated and extracted using a relationship generation module.

What is claimed is:

1. A system for extracting concepts and relationships from a text, comprising:
a processor that is adapted to execute stored instructions; and
a memory device that stores instructions, the memory device comprising processor-executable code, that when executed by the processor, is adapted to:
generate concepts from the text using singular value decomposition;
rank the concepts based on a term weight and a distance metric;
extract the concepts iteratively that are ranked above a particular threshold;
merge the concepts to form larger concepts until concept generation has stabilized;
generate relationships based on the concepts using singular value decomposition;
rank the relationships based on various metrics; and
extract the relationships that are ranked above a particular threshold.

2. The system recited in claim 1, wherein the memory device comprises processor-executable code, that when executed by the processor, is adapted to generate concepts from the text using singular value decomposition by:
creating a matrix to generate concepts, said matrix having rows that represent unigrams or multi-grams and columns that represent documents; and
expressing the matrix as a product of three matrices, including a diagonal matrix of singular values ordered in descending order, a matrix representing terms, and a matrix representing documents, using singular value decomposition.

3. The system recited in claim 1, wherein the memory device comprises processor-executable code, that when executed by the processor, is adapted to generate relationships based on the concepts using singular value decomposition by:
creating a matrix to generate relationships, said matrix having rows that represent single words, concepts, and triples and columns that represent documents; and
expressing the matrix another as a product of three matrices using singular value decomposition.

4. The system recited in claim 1, wherein the various metrics include another term weight, another distance metric, a number of elementary words in the concepts connected by the relationship, or a TFIDF weight of the concepts.

5. The system recited in claim 1, wherein seed concepts are provided.

6. The system recited in claim 1, wherein the relationship is expressed by one or more verbs, or a verb and a preposition, or a noun and a preposition, or any other pattern known for relationships.

7. The system recited in claim 1, wherein a mind map of concepts and relationships is rendered.

8. A method of extracting concepts and relationships from a text, comprising:
generating concepts from the text using singular value decomposition;
ranking the concepts based on a term weight and a distance metric;
extracting the concepts iteratively that are ranked above a particular threshold;
merge the concepts to form larger concepts until concept generation has stabilized;
generating relationships based on the concepts using singular value decomposition;
ranking the relationships based on various metrics; and
extracting the relationships that are ranked above a particular threshold.

9. The method recited in claim 8, wherein generating concepts from the text using singular value decomposition comprises:
creating a matrix to generate concepts, said matrix having rows that represent unigrams or multi-grams and columns that represent documents; and
expressing the matrix as a product of three matrices, including a diagonal matrix of singular values ordered in descending order, a matrix representing terms, and a matrix representing documents, using singular value decomposition.

10. The method recited in claim 8, wherein generating relationships based on the concepts using singular value decomposition comprises:
creating a matrix to generate relationships, said matrix having rows that represent single words, concepts, and triples and columns that represent documents; and
expressing the matrix another as a product of three matrices using singular value decomposition.

11. The method recited in claim 8, wherein the various metrics include another term weight, another distance metric, a number of elementary words in the concepts connected by the relationship, or a TFIDF weight of the concepts.

12. The method recited in claim 8, wherein seed concepts are provided.

13. The method recited in claim 8, wherein the relationship is expressed by one or more verbs, or a verb and a preposition, or a noun and a preposition, or any other pattern known for relationships.

14. The method recited in claim 8, wherein a mind map of concepts and relationships is rendered.

15. A non-transitory, computer-readable medium, comprising code configured to direct a processor to:
pre-process documents using a pre-process module;
generate concepts from the pre-processed documents using singular value decomposition;
rank the concepts based on a term weight and a distance metric;
extract the concepts that are ranked above a particular threshold using an iterative concept generation module;
merge the concepts to form larger concepts until concept generation has stabilized;
generate relationships based on the concepts using singular value decomposition;
rank the relationships based on various metrics; and
extract the relationships that are ranked above a particular threshold using a relationship generation module.

16. The non-transitory, computer-readable medium recited in claim 15, comprising code configured to direct a processor to generate concepts from the pre-processed documents using singular value decomposition by:
creating a matrix to generate concepts, said matrix having rows that represent unigrams or multi-grams and columns that represent documents; and
expressing the matrix as a product of three matrices, including a diagonal matrix of singular values ordered in descending order, a matrix representing terms, and a matrix representing documents, using singular value decomposition.

17. The non-transitory, computer-readable medium recited in claim 15, comprising code configured to direct a processor to generate relationships based on the concepts using singular value decomposition by:
creating a matrix to generate relationships, said matrix having rows that represent single words, concepts, and triples and columns that represent documents; and
expressing the matrix another as a product of three matrices using singular value decomposition.

18. The non-transitory, computer-readable medium recited in claim 15, wherein the various metrics include another term weight, another distance metric, a number of elementary words in the concepts connected by the relationship, or a TFIDF weight of the concepts.

19. The non-transitory, computer-readable medium recited in claim 15, wherein seed concepts are provided or a mind map of concepts and relationships is rendered.

20. The non-transitory, computer-readable medium recited in claim 15, wherein the relationship is expressed by one or more verbs, or a verb and a preposition, or a noun and a preposition, or any other pattern known for relationships.
